(19) United States
(12) Patent Application Publication
(10) Pub. No.: US 2023/0348245 A1
(43) Pub. Date: Nov. 2, 2023

(54) VEHICLE SUPPORT FOR USE WITH A TWO-POST VEHICLE LIFT, AND CORRESPONDING SYSTEMS AND METHODS

(71) Applicant: Rudolph C. Raslavsky, JR., Milford, CT (US)

(72) Inventor: Rudolph C. Raslavsky, JR., Milford, CT (US)

(21) Appl. No.: 18/142,177

(22) Filed: May 2, 2023

Related U.S. Application Data
(60) Provisional application No. 63/337,286, filed on May 2, 2022.

(51) Int. Cl. B66F 7/28

(52) U.S. Cl. CPC B66F 7/28

(57) ABSTRACT

A removable vehicle lift attachment for two-post automotive lifts is disclosed herein comprising a first and second vehicle support platforms upon which a vehicle can be supported by its wheels and featuring installed tracks for adjustment of the platforms to a vehicle’s wheelbase. Corresponding systems and methods also are disclosed.

### RELATED APPLICATIONS

This application claims the benefit of U.S. Provisional Pat. Application No. 63/337,286 filed May 2, 2022, the contents of which are incorporated by reference herein in their entirety.

### BACKGROUND

This disclosure relates generally to vehicle supports, and more particularly to an apparatus and method for supporting a vehicle during maintenance.

Devices for lifting automobiles, trucks and motorcycles to facilitate mechanical work are generally known. These lifts, which enable a mechanic to access the vehicle from the underside, often support the body of the car. However, when antique vehicles, muscle car and convertibles are being serviced, lifts that support the body may cause the vehicle to sag or bow, and therefore a lift that supports the wheels is preferred.

It would be useful to develop improved lift devices that can be used to lift non-traditional vehicles.

### SUMMARY

One embodiment described herein is a vehicle support for a two-post vehicle lift, comprising a first vehicle support platform and a second vehicle support platform upon which a vehicle with first, second, third and fourth wheels can be supported and lifted, each vehicle support platform having a first end portion and an opposite second end portion, and including an upper surface configured to support two wheels and a lower surface having a track formed thereon with a longitudinal channel configured to receive two mounting plates of the two-post vehicle lift. The vehicle support also includes a first on-ramp having a first end portion configured to be in contact with a floor during use, and a second end portion removably attached to the first end portion of the first vehicle support, and a second on-ramp having a first end portion configured to be in contact with the floor during use and a second end portion removably attached to the second end portion of the second vehicle support, the second end portion of each on-ramp having a height in the range of about 6 inches to about 18 inches. The device also includes a first stop box connected to the second end portion of the first vehicle support and a second stop box connected to the second end portion of the second vehicle support, each stop box having a support component configured to support the second end portion of the vehicle support at a height in the range of about 6 inches to about 18 inches off of the floor when the stop box is positioned on the floor. The first vehicle support platform extends horizontally when attached to both the first on-ramp and the first stop box, and the second vehicle support platform extends horizontally when attached to both the second on-ramp and the second stop box.

Another embodiment described herein is method comprising obtaining first and second vehicle support platforms having mounting-plate-receiving tracks on the lower surface thereof, first and second on-ramps, and first and second stop boxes, connecting the first vehicle support platform to the first stop box, and connecting the second vehicle support platform to the second stop box. The lift legs of a two-post lift are adjusted to have a desired separation distance, with the legs in a lower position. The method further includes sliding the first track along two mounting plates connected to a first lift leg of the two-post lift, sliding the second track along two mounting plates connected to a second lift leg of the two-post lift, and fixing the positions of the first and second tracks relative to the first and second lift legs. The method further includes removably connecting the first vehicle support platform to the first on-ramp, removably connecting the second vehicle support platform to the second on-ramp, moving a vehicle on the first and second vehicle support platforms, removing the first and second on-ramps, and lifting the vehicle for servicing.

Yet another embodiment is a vehicle lift attachment comprising a first platform and a second platform upon which a vehicle could be supported by its wheels, and at least one track attached to each platform comprising parallel first and second guiding members forming a channel by which the platforms are configured to be attached to a two post vehicle lift.

Another embodiment is a method comprising positioning and attaching of a platform to a set of articulating lift-legs via insertion of the pad adapters or similar apparatus into the sliding tracks of the platform, adjusting the platform horizontally, adjusting the vehicle lift so that the legs are in their lowest position, driving or otherwise rolling the vehicle onto the platforms via the ramps so that all tires are securely resting on the platforms, and lifting and/or lowering the vehicle as it is supported by the platforms to service the vehicle.

A further embodiment is method comprising positioning and attaching of a first platform to a set of articulating lift-legs via insertion of the pad adapters or similar apparatus into the sliding tracks of the platform, positioning and attaching of a second platform to the second set of articulating lift-legs via insertion of the pad adapters or similar apparatus into the sliding tracks of the platform, adjusting the first and second platforms horizontally, and adjusting the articulating lift legs so that the legs and all attached apparatus are in their lowest position. The method further includes driving or rolling a vehicle onto the platforms via the ramps so that all tires are securely resting on the platforms, lifting the vehicle as it is supported by the platforms to service the vehicle. When work has been completed, the vehicle is lowered for removal from the platform.

### BRIEF DESCRIPTION OF THE DRAWINGS

FIG. 1 shows a top perspective view of a first embodiment of a vehicle lift support.

FIG. 2 shows a bottom perspective view of the first embodiment.

FIG. 3 depicts a side view of the support.

FIG. 4 shows an end view thereof.

FIG. 5 shows a top plan view.

FIG. 6 depicts an end view of a ramp guide for the first embodiment.

FIG. 7 shows a perspective view of the ramp guide.

FIG. 8 shows an end view of the base guide for the first embodiment.

FIG. 9 shows a perspective view of the base guide.

FIG. 10 shows a perspective view of a guiding member used to form a track of the first embodiment.

FIG. 11A shows an end view of the guiding member of the first embodiment.

FIG. 11B illustrates shows an end view of an L-shaped guiding member that can be used with the first embodiment.

FIG. 11C shows an end view of an E-shaped guiding member that can be used with the first embodiment.

FIG. 11D shows an end view of an F-shaped guiding member that can be used with the first embodiment.

FIG. 12 is a top view of a second embodiment.

FIG. 13 is a bottom view of the second embodiment.

FIG. 14 depicts a cross sectional view of the second embodiment.

FIG. 15 shows a side view of the vehicle on-ramp of the second embodiment.

FIG. 16 shows a bottom view of the vehicle on-ramp of the second embodiment.

FIG. 17 is a perspective view of the stop box of the second embodiment.

FIG. 18 is a rear end view of the second embodiment when connected to a two-post vehicle lift.

FIG. 19 is a photo of a third embodiment with an automobile mounted thereon.

FIG. 20 is a photo of an adapter showing a connection of the third embodiment to a leg of two-post lift.

### DETAILED DESCRIPTION

The lift apparatus described herein is characterized as a universal attachment for a two-post automotive lift including two platforms, usually made of metal, each with one ramp for vehicle drive-on access. The attachments are designed to affix to the automotive lift legs by allowing traditional automotive lift pins or similar attachments to insert into a slotted track along the base of each steel plate. Once the lift has been raised and the pivotable ramps drop or are removed, tire-stops optionally affixed to the ramps will protrude past the top of the baseplates to prevent vehicle roll-off. An additional stop optionally exists at the front of each steel plate for the same purpose. The design allows for the telescoping lift legs and drive-on lift attachments to be adjusted to fit the wheelbase of various vehicles. The design is particularly useful for working on muscle cars, which tend to sag in the middle when a conventional two-post lift is used.

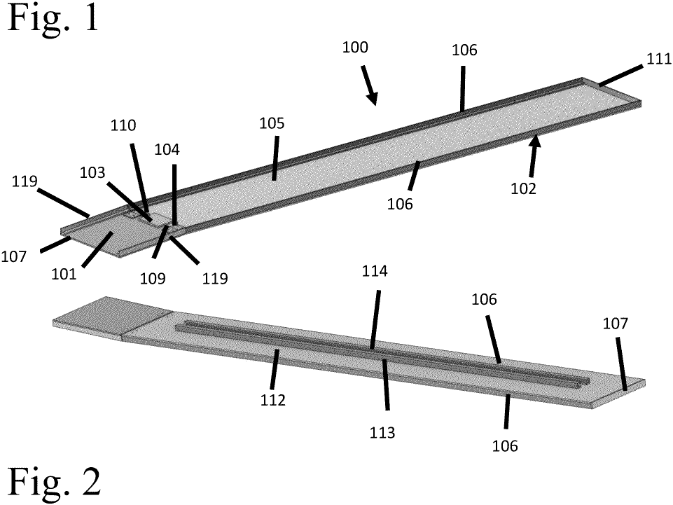

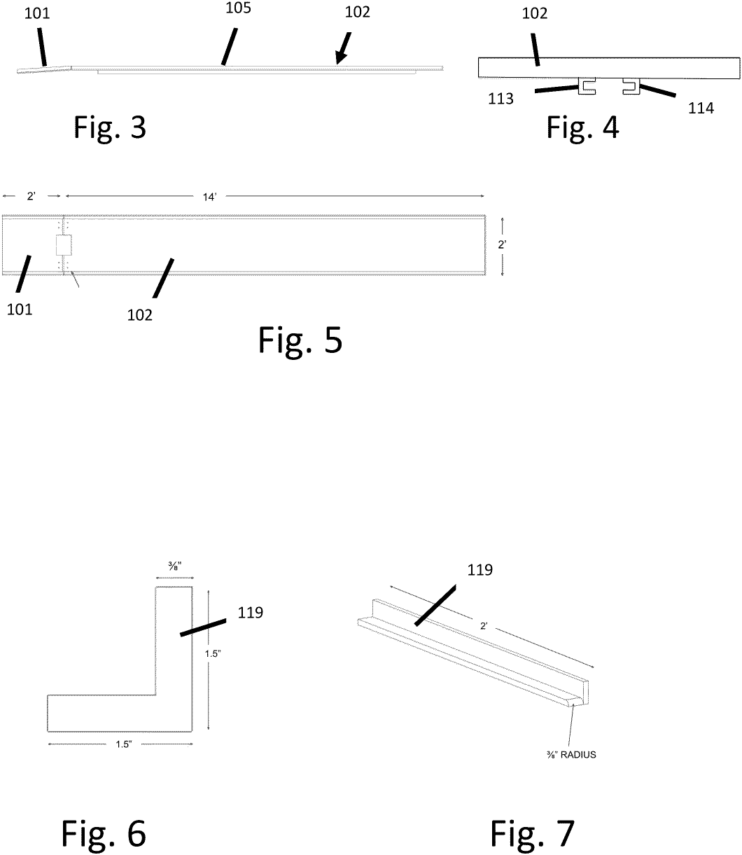

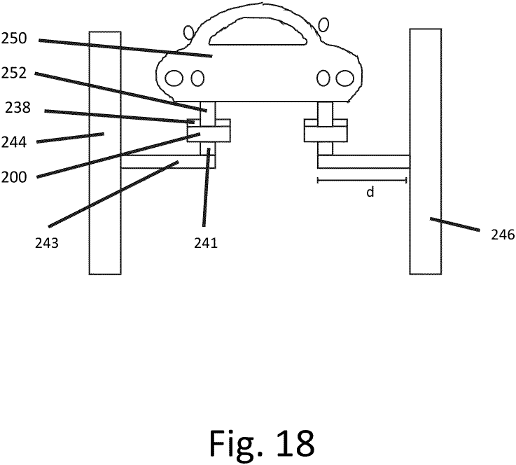

Referring to the drawings, FIG. 1-11D show a first embodiment of a vehicle lift support, generally designated as 100. Two vehicle lift supports 100 are used together in a parallel arrangement with a two-post lift to support a vehicle to be serviced, is shown in FIG. 18.

A top perspective view of the vehicle lift support 100 is shown in FIG. 1. The vehicle lift support 100 includes a vehicle on-ramp 101 configured to allow a vehicle to smoothly drive onto a vehicle support platform 102. The vehicle on-ramp 101 is pivotally connected to the vehicle support platform 102 by a pair of hinges 104, which allow the on-ramp 101 to pivot such that a first end 107 is on the floor while a second end 109, connected to a first end 110 of the vehicle support platform 102, is elevated. A front stop plate 103 formed near the first end 110 of the vehicle support platform 102 on its upper side can be pivoted upwardly in order to prevent a vehicle from rolling off of the vehicle support platform 102 down the on-ramp 101. A back stop plate 107 is formed at the second end 111 of the support platform to prevent the vehicle from rolling off the second end 111 of the vehicle support platform 102.

The vehicle on-ramp 101 has a pair of longitudinally upwardly extending ramp guides 119 on opposite sides to guide the wheels of a vehicle as it is driven onto the vehicle support platform. In one embodiment, shown in FIGS. 6-7, each ramp guide 119 has an L-shaped cross section and the horizontally extending lower portion 120 is permanently mounted to a lower surface 121 of the vehicle on-ramp 101. In embodiments, the vehicle on-ramp 101 has a length in the range of about 1 foot to 3 feet, or about 2 feet, and a width of about 1 ½ feet to about 2 ½ feet, or about 2 feet. The vehicle on-ramp 101 usually has the same width as the vehicle support platform 102.

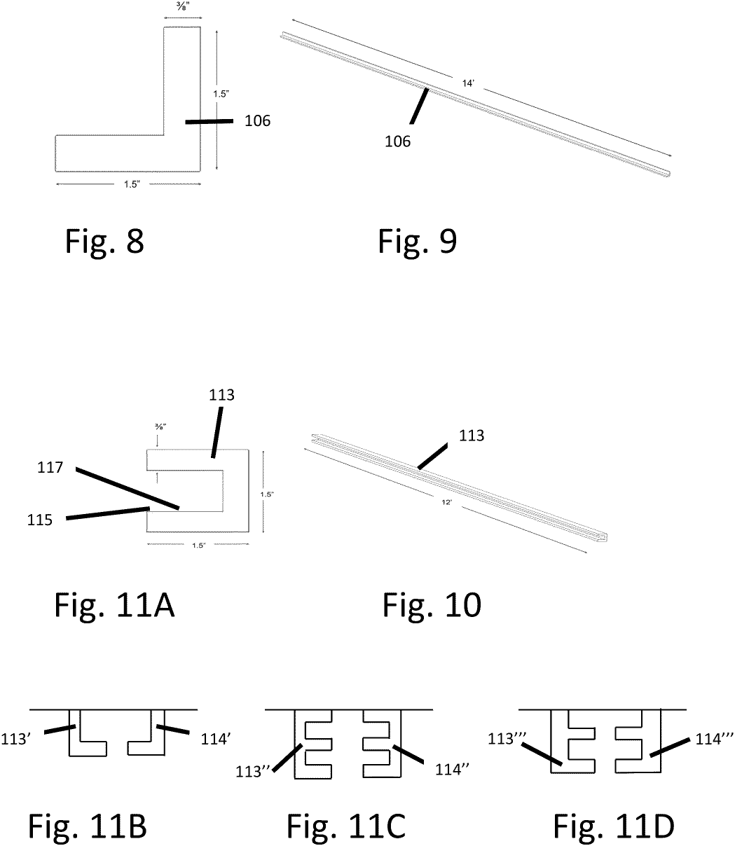

The vehicle support platform 102 has an upper surface 105 configured to be in contact with a vehicle, and a lower surface 112 configured to be in contact with a leg component of a two-post lift. A pair of longitudinal upwardly extending lips 106, 108, also referred to as base guides, are formed on the left and right sides of the vehicle support platform to assist in centering a vehicle when a pair of parallel vehicle support platforms 102 are mounted to a two-post list. In one embodiment, the lips 106,108 are formed by fastening beams having an L-shaped cross section to the lower surface of the vehicle support platform 102. A beam of this configuration is shown in FIGS. 8-9. When the vehicle lift support 101 is in use to service a 4-wheeled vehicle, the left front and left rear tires of a vehicle rest on a left support platform 102 and the right front and right rear tires of a vehicle rest on a right support platform 102′. In embodiments, the vehicle support platform 105 has a length of about 12 feet to about 16 feet, and therefore the overall length of the vehicle lift support is about 16 to about 20 feet, or about 17 to about 19 feet, or about 18 feet.

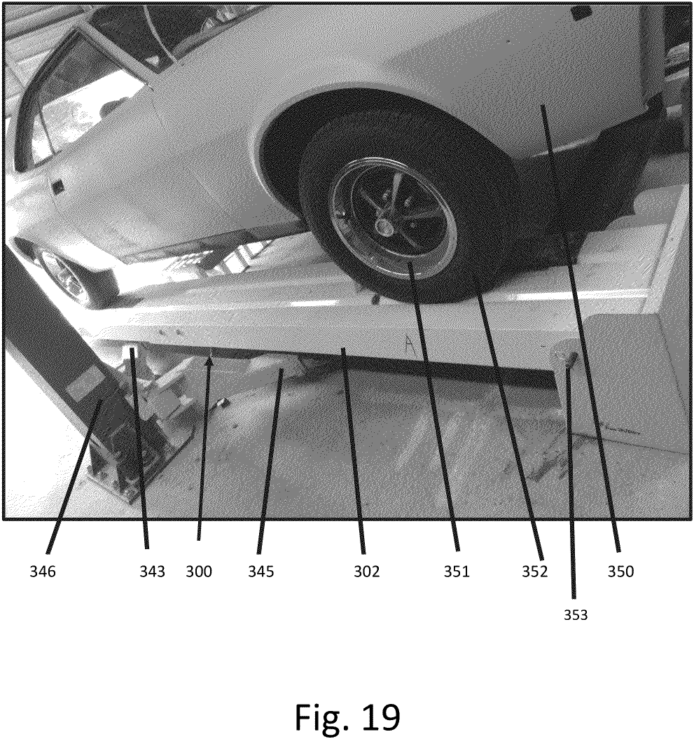

FIG. 2 shows a bottom perspective view of the vehicle support platform 105. The lower surface 112 has a longitudinally extending track 108 that includes a pair of parallel guiding members 113, 114. In the embodiment shown in FIGS. 2, 10 and 11A, the guiding members 113, 114 have a rectangular C-shaped configuration forming a channel 117 dimensioned to receive first and second support plates of a first component of a lift leg on a conventional two-post lift (the lift is shown in FIG. 19). The open sides 115, 116 of the guiding members 113, 114 face inwardly toward one another. The guiding members 113, 114 are configured to receive lift-mounted adapters and/or pads set on telescoping lift legs of a vehicle lift to provide for movement of the lift legs in conjunction with the vehicle support platforms 102.

In the embodiment shown in FIGS. 10 and 11A, the channel 117 has a width of about ¾ inch to about 1 ½ inch and a depth of about 1 inch. The support plates of a two-post lift can slide along the track on the bottom side of the support platform 105, restrained by the guiding members 113, 114, to a suitable longitudinal location based upon the desired width between first and second vehicle support platforms 102. The arrangement enables an operator to adjust the distance between the parallel vehicle lift supports 100 depending on the width of the vehicle to be mounted on the vehicle support platforms 102. As alternatives, guiding members 113, 114 can have an L-shaped cross section, shown in FIG. 11B (see 113′ and 114′), an E-shaped configuration as shown in FIG. 11C (see 113″ and 114″), or an upside down F-shaped cross section, shown in FIG. 11D (see 113‴ and 113‴). The guiding members 113, 114 are permanently mounted to the vehicle support platform 102. In embodiments, the guiding members 113, 114 have a length is the range of about 9 feet to about 16 feet, or about 11 feet to about 13 feet.

To use the vehicle lift support, left and rights vehicle lift supports 100 are attached to left and right articulating lift legs of a two post lift in order that the vehicle lift supports 100 are parallel to one another. In embodiments, the vehicle lift supports 100 are attached by insertion of pad adapters (described below) or a similar apparatus into the sliding tracks of the platform, and then the vehicle support platform 102 are lowered to be near the floor. A vehicle is then driven or rolled onto the platforms via the ramps so that all wheels are securely resting on the platforms, and the vehicle support platforms are then lifted to a height suitable for performing maintenance work on the vehicle. When the work has been completed, the steps are reversed. The vehicle support platforms are lowered to be close to the floor and then the vehicle or driven off or rolled off of the vehicle support platforms 102.

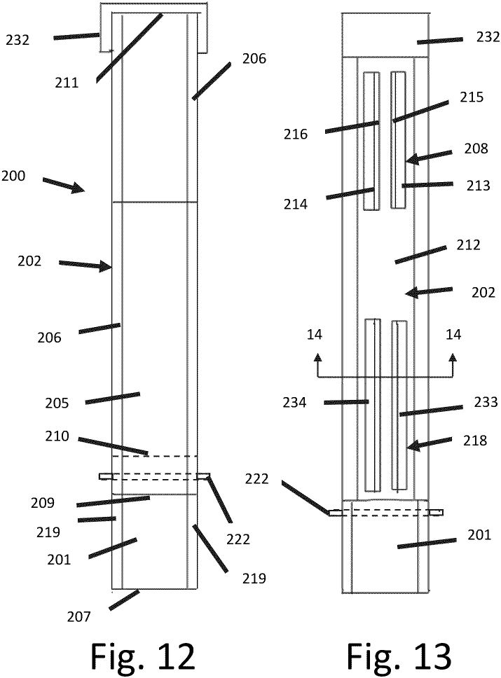

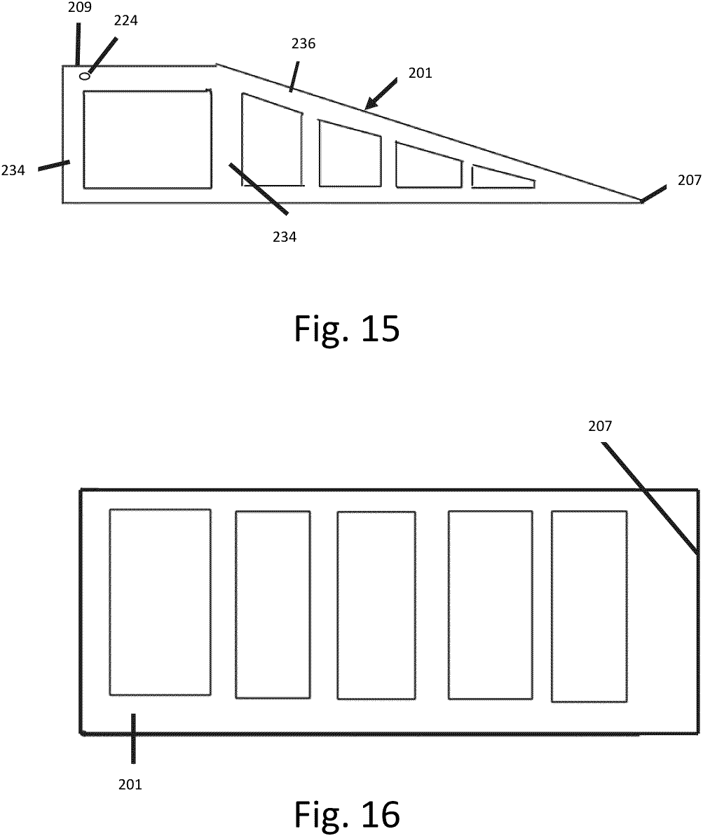

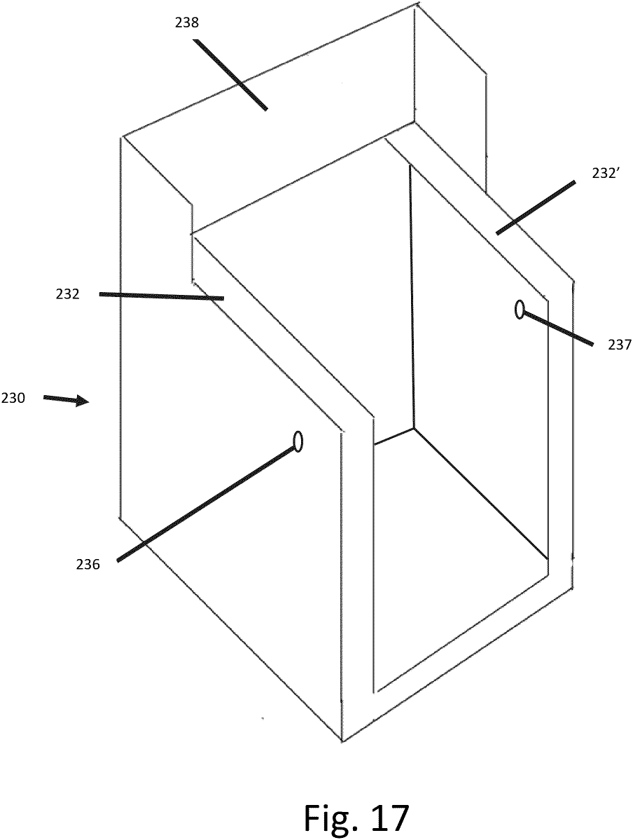

Referring to the drawings, FIGS. 12-18 show a second embodiment of a vehicle lift support, generally designated as 200. Two vehicle lift supports 200 are used together in a parallel arrangement with a two-post lift to support a vehicle to be serviced, is shown in FIG. 18.

A top plan view of the vehicle lift support 200 is shown in FIG. 12. The vehicle lift support 200 includes a vehicle on-ramp 201 configured to allow a vehicle to smoothly drive onto a vehicle support platform 202. The vehicle on-ramp 201 is temporarily connected to the vehicle support platform 202 with a rod 222, which extends through ramp bores 224 formed on the sides of the ramp near the second end 209 (upper end), and pivot such that a first end 207 touches the floor. In embodiments, the second end 209 (upper end) of the ramp is about 8 to 14 inches from the floor, or about 11 to 13 inches off of the floor. The height of the ramp is generally equivalent to the height of first and second shelves 232, 233 of a stop box 230, which is shown in FIG. 16 and is mounted to the second end 211 of the vehicle support platform 202 in order that the vehicle support platforms 202 are horizontally positioned when resting on the shelves 232, 232′ of the stop box 230 and mounted to the on-ramp 201. Apertures 236, 237 receive a pin or dowel that connects the stop box to the vehicle support platforms, as can be seen in the third embodiment (FIG. 19) as pin 353.

The vehicle on-ramp 201 gradually tapers upwardly from one end of the other. In the embodiment shown in FIGS. 12-13 and 15-16, the vehicle on-ramp 201 includes a plurality of vertical support posts 234 that provide support to a diagonal, upwardly extending on-ramp platform portion 236. The vehicle on-ramp 201 has a pair of longitudinally extending ramp guides 219 on opposite sides to guide the wheels of a vehicle as it is driven onto the vehicle support platform. In embodiments, the vehicle on-ramp 201 has a length in the range of about 1 foot to 6 feet, or about 3 feet to about 5 feet, and a width of about 1 ½ feet to about 2 ½ feet, or about 2 feet. The vehicle on-ramp 201 usually has the same width as the vehicle support platform 202. In some cases, the ramp has a length along the floor of about 4 feet and a height at the upper end of about 1 foot above the floor.

The vehicle support platform 202 has an upper surface 205, shown in FIG. 12, configured to be in contact with a vehicle, and a lower surface 212, shown in FIG. 13, configured to be in contact with a mounting plate attached to a lift leg of a two-post lift. A pair of longitudinal upwardly extending lips 206, 208, also referred to as base guides, are formed on the left and right sides of the vehicle support platform to assist in centering a vehicle when a pair of parallel vehicle support platforms 202 are mounted to a two-post list. In one embodiment, the lips 206, 208 are formed by welding beams to the sides of the vehicle support platform 202. When the vehicle lift support 201 is in use to elevate a 4-wheeled vehicle, the left front and left rear tires of a vehicle rest on a left support platform 202 and the right front and right rear tires of a vehicle rest on a right support platform 202′. In embodiments, the vehicle support platform 105 has a length of about 12 feet to about 16 feet, and therefore the overall length of the vehicle lift support is about 16 to about 20 feet, or about 17 to about 19 feet, or about 18 feet.

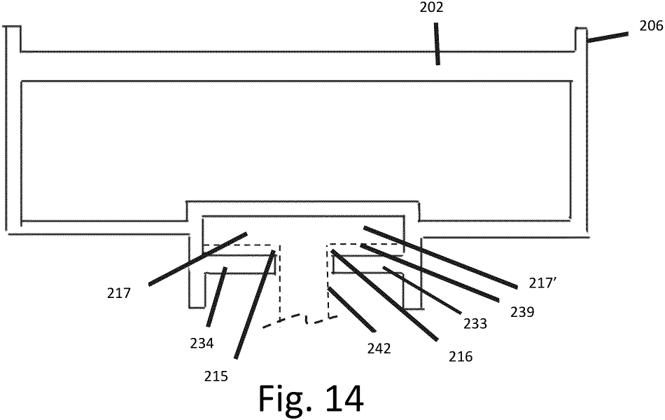

FIG. 13 shows a bottom view of the vehicle support platform 205. FIG. 14 shows a side sectional view of the vehicle support platform 205 taken along line 14-14 of FIG. 13. The lower surface 212 has two sets of longitudinally extending and longitudinally spaced tracks 208, 218. Track 208 is on the first end portion 236, which is near the first end 210 of the vehicle support platform 202. Track 218 is on the second end portion 238, which is near the second end 211 of the vehicle support platform 202. Tracks 208 and 218 each include a pair of parallel guiding members. More specifically, track 208 includes guiding members 213, 214 and track 218 includes guiding members 233 and 234. Guiding members 213, 214 receive a mounting plate that is mounted to a first telescoping arm component of a first leg of a two-post lift, and guiding members 233, 234 receive a mounting plate that is mounted to a second telescoping arm component (of the same leg) of a two-post lift. The other leg of the two-post lift also has a vehicle lift support 200 mounted thereto. In the embodiment shown in FIGS. 13-14, the guiding members 213, 214 have an F-shaped configuration (and the guiding members or F’s are connected to one another) forming a channel 217 dimensioned to receive a support plate of a first component of a lift leg on a conventional two-post lift. The guiding members 233, 234 have an F-shaped configuration forming a channel 237 dimensioned to receive a support plate of a second component of the same lift leg. The open sides 215, 216 of the guiding members 213, 214 face inwardly toward one another. Similarly, the open sides of the guiding members 233, 234 face inwardly toward one another. The guiding members 213, 214 are configured to receive lift-mounted adapters 238 mounted to telescoping lift arm components 240, 242 of one of the posts 244, 246 of a two-post vehicle lift. The combination of telescoping and horizontally pivoting of the lift arm components (2 arm components extending from each post) enable an operator to customize the distance between two parallel vehicle lift supports 200.

In the embodiment shown in FIG. 14, the left channel 217 has a width (extending from left to right on the figure) of about ¾ inch to about 1 ½ inch and a depth (extending vertically on the figure) of about 1 inch. The right channel 217′ has a width (extending from left to right on the figure) of about ¾ inch to about 1 ½ inch and a depth (extending vertically on the figure) of about 1 inch. The position of a mounting plate when the apparatus is in use is shown in broken lines in FIG. 14 as 239. The mounting plates of a two-post lift (shown in FIG. 18) can slide along the tracks on the bottom side of the support platform 205, restrained by the guiding members 213, 214, and 233, 234, to a suitable longitudinal location based upon the desired width between first and second vehicle support platforms 202. The arrangement enables an operator to adjust the distance between the parallel vehicle lift supports 200 depending on the width of the vehicle to be mounted on the vehicle support platforms 202. As alternatives, guiding members 213, 214 can have an L-shaped cross section, an E-shaped cross section, or a C-shaped cross section. In embodiments, the guiding members 213, 214 and 233, 234 are permanently mounted to the vehicle support platform 202. In embodiments, the guiding members 213, 214 have a length in the range of about 3 feet to about 6 feet, or about 4 feet to about 5 feet. The guiding members 233, 234 have a similar length.

To use the vehicle support, left and right vehicle support platforms 202 are attached to left and right articulating lift legs 240, 242 of a two-post lift in order that the vehicle support platforms 202 are parallel to one another. In embodiments, each vehicle lift support platform 202 is attached by insertion of mounting plates 239 supported by an adapter 241 or a similar apparatus into the sliding tracks 208 of the platform 202, and the vehicle support platforms 202 are lowered to be near the floor. Each vehicle lift support platform 202 is supported by two mounting plates 239, 240. One mounting plate is in track 208 and the other mounting plate is in track 218. After the vehicle on-ramps 201 and stop boxes 230 are attached to the vehicle support platforms 202, which may be before or after attachment to the mounting plates 239, a vehicle 250 with tires 252, shown in FIG. 18, is then driven or rolled onto the platforms via the ramps so that all tires 252 are securely resting on the platforms. The stop box 230 and vehicle on-ramp 201 maintain the vehicle support platforms in a horizontal position during loading of the vehicle. After the vehicle is loaded, the on-ramps 201 optionally can be removed, or can be pivoted or slid such that they are out of the way. The vehicle support platforms are then lifted to a height suitable for performing maintenance work on the vehicle. When the work has been completed, the steps are reversed. The vehicle support platforms 202 are lowered to be close to the floor and then the vehicle 250 is driven off or rolled off of the vehicle support platforms 202.

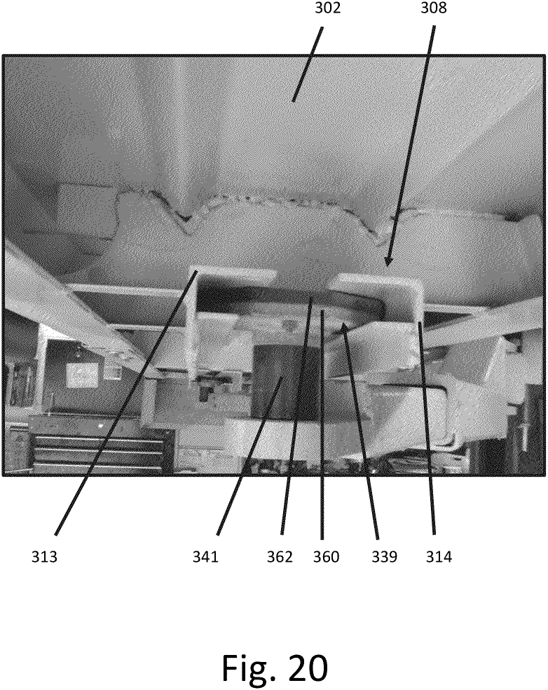

FIGS. 19-20 show a third embodiment in use with a two-post lift. These figures show a system that includes a two-post lift together with a vehicle lift support 300. The two-post lift supports a vehicle (car) 350 with wheels 351, and tires 352 which are in direct contact with a vehicle lift support 300. Post 334 has a lift leg with first arm 343 and second arm 345 extending outwardly therefrom, supporting vehicle support platform 302. The first and second arms 343, 345 are telescoping and horizontally pivotable. FIG. 20 shows F-shaped guiding members 313 and 314 which form a track 308. Adapter 241 supports mounting plate 339 that is fixed in position along the track 308 during use of the vehicle lift support 300. Mounting plate 339 includes a lift plate 360, which typically is made of metal, and an upper lift plate cushion 362 mounted on the lift plate 360 to provide cushioning between the metal of the lift plate 360 and the metal of the lower side of the upper horizontal wall of the guiding member 313.

The attachments can be configured for use with a lift having a capacity up to 7000 pounds, or up to 9000 pounds, or up to 10,000 pounds.

A number of alternatives, modifications, variations, or improvements therein may be subsequently made by those skilled in the art, which are also intended to be encompassed by the following claims.

What is claimed is:

1. A vehicle support for a two-post vehicle lift, comprising:
a first vehicle support platform and a second vehicle support platform upon which a vehicle with first, second, third and fourth wheels can be supported and lifted, each vehicle support platform having a first end portion and an opposite second end portion, and including an upper surface configured to support two wheels and a lower surface having a track formed thereon with a longitudinal channel configured to receive two mounting plates of the two-post vehicle lift,
a first on-ramp having a first end portion configured to be in contact with a floor during use, and a second end portion removably attached to the first end portion of the first vehicle support, and a second on-ramp having a first end portion configured to be in contact with the floor during use and a second end portion removably attached to the second end portion of the second vehicle support, the second end portion of each on-ramp having a height in the range of about 6 inches to about 18 inches,
a first stop box connected to the second end portion of the first vehicle support and a second stop box connected to the second end portion of the second vehicle support, each stop box having a support shelf configured to support the second end portion of the vehicle support at a height in the range of about 6 inches to about 18 inches off of the floor when the stop box is positioned on the floor,
wherein the first vehicle support platform extends horizontally when attached to both the first on-ramp and the first stop box, and the second vehicle support platform extends horizontally when attached to both the second on-ramp and the second stop box.

2. The vehicle support of claim 1, wherein each track includes parallel first and second guiding members forming the channel.

3. The vehicle support of claim 1, wherein each post of the two-post lift has a mounting leg with first and second leg components, and each mounting plate is attached to a leg component of the two-post lift with an adapter.

4. The vehicle support of claim 1, wherein the leg components of the two-post lift are telescoping and pivotable to provide for adjustment of the distance between the first and second vehicle lift supports when mounted on the two-post lift.

5. The vehicle support of claim 1, wherein the first and second on-ramps are pivotally connected to the first and second vehicle support platforms.

6. The vehicle support of claim 1, further comprising a pivotable first stop plate positioned at the first end portion of the first vehicle support platform and a pivotable second stop plate positioned at the second end portion of the second vehicle support platform, the first and second stop plates being configured to pivot upwardly after the first and second on-ramps have been removed to prevent vehicle roll-off.

7. The vehicle support of claim 1, wherein each vehicle support platform has longitudinally and upwardly extending lips to guide the vehicle when the vehicle is moved on and off of the vehicle support platforms.

8. The vehicle support of claim 2, wherein each of the guiding members has at least one of an L-shaped cross section, a C-shaped cross section, and E- shaped cross section and an F-shaped cross section.

9. The vehicle support of claim 1, wherein the stop box support component comprises at least one support shelf.

10. The vehicle support of claim 1, wherein each stop box includes a stop wall configured to prevent roll-off of a vehicle during use.

11. A method comprising:
obtaining first and second vehicle support platforms having mounting-plate-receiving tracks on the lower surface thereof, first and second on-ramps, and first and second stop boxes,
connecting the first vehicle support platform to the first stop box, and connecting the second vehicle support platform to the second stop box,
adjusting the lift legs of a two-post lift to have a desired separation distance, with the legs in a lower position,
sliding the first track along two mounting plates connected to a first lift leg of the two-post lift, and sliding the second track along two mounting plates connected to a second lift leg of the two-post lift, and fixing the positions of the first and second tracks relative to the first and second lift legs,
removably connecting the first vehicle support platform to the first on-ramp, and removably connecting the second vehicle support platform to the second on-ramp,
moving a vehicle on the first and second vehicle support platforms,
removing the first and second on-ramps, and
lifting the vehicle for servicing.

12. The method of claim 11, further comprising lowering the vehicle and removing the vehicle from the vehicle support platforms.

13. The method of claim 11, wherein, during sliding, each of the first track and the second track of each vehicle support platform is generally positioned with its longitudinal midpoint halfway between each of the mounting plates to which it is connected.
